(19) United States
(12) Patent Application Publication
(10) Pub. No.: US 2011/0276476 A1
(43) Pub. Date: Nov. 10, 2011

(54) SYSTEM FOR SENDING ELECTRONIC MONEY AND METHOD FOR SENDING ELECTRONIC MONEY

(75) Inventor: Jong Ho Kim, Gyeonggi-do (KR)

(73) Assignee: SK TELECOM CO., LTD., Seoul (KR)

(21) Appl. No.: 13/144,882

(22) PCT Filed: May 18, 2010
(86) PCT No.: PCT/KR10/03125

§ 371 Date: Jul. 15, 2011

(30) Foreign Application Priority Data
Jun. 4, 2009 (KR) 10-2009-0049372

(51) Int. Cl. G06Q 40/00

(52) U.S. Cl. 705/39

(57) ABSTRACT

A system for remitting electronic money and a method for remitting electronic money, by which subscriber identification information of each user can be used as a virtual electronic money account and electronic money can be conveniently exchanged/remitted between different countries by using the subscriber identification information.

### TECHNICAL FIELD

The present invention relates to a system for remitting electronic money, and more particularly to a system for remitting electronic money and a method for remitting electronic money, an electronic money server and a method for processing remittance by the electronic money server, and a relay server and a method for processing remittance by the relay server, by which subscriber identification information of each user can be used as a virtual electronic money account and electronic money can be conveniently exchanged/remitted between different countries by using the subscriber identification information.

### BACKGROUND ART

The term “electronic money” refers to virtual money having a predetermined monetary value received from an addressor to whom the price has been paid.

Electronic money has advantages such that it has relatively little risk such as either forgery, falsification or the like, is safe even when it is lost or stolen, and is convenient for micropayment.

With the types of electronic money payment services, which support this electronic money, becoming diverse, the number of users who use electronic money having actual monetary value keeps increasing, and the use range of the electronic money is expanding globally.

Meanwhile, the world is gradually becoming unified by virtue of the development of various means of transportation and that of various means of communication. As people have a growing number of friends in other countries by virtue of the above world's unification, a roaming service among mobile communication services is also becoming generalized globally. In this regard, users who reside in a predetermined country not only communicate with their friends in other countries, but also have a growing number of financial dealings with them.

However, some countries, particularly, Southeast Asian countries lag behind advanced countries in their bank networks, and thus have poor bank networks.

Considering that people are very sensitive in thinking of financial dealings, since the users do not rely on having their financial dealings (i.e. remittance) with their friends of other countries through the poor bank networks as described, the users have difficulties in having financial dealings (i.e. remittance) with their friends in other countries.

### DISCLOSURE

### Technical Problem

Therefore, the present invention has been made to solve the above-mentioned problems occurring in the prior art, and an object of the present invention is to provide a system for remitting electronic money and a method for remitting electronic money, in which a service server provides a remittance request signal according to a remittance request when receiving the remittance request including subscriber identification information of a remittee from a predetermined terminal apparatus, an electronic money server, which manages an electronic money account corresponding to the subscriber identification information of each user, requests a relay server for confirmation of the remittee and currency exchange/remittance according to the remittance request signal when receiving the remittance request signal, and the relay server identifies a country of the remittee based on the remittance request signal, exchanges the amount of electronic money to be remitted according to the remittance request signal for the currency of the country of the remittee based on exchange rate information of each nation, and then provides an electronic money server in the country of the remittee with a remittance signal including the information on the amount of the exchanged currency in response to the remittance request signal, so that the subscriber identification information of each user can be used as a virtual electronic money account and electronic money can be conveniently exchanged/remitted between different countries by using the subscriber identification information.

Also, another object of the present invention is to provide an electronic money server and a method for processing remittance by the electronic money server, in which an external relay server is requested for identification of a remittee and currency exchange/remittance according to a remittance request signal when the remittance request signal including subscriber identification information of the remittee is received from an external service server, the amount of electronic money is reduced by that of the remitted electronic money in an electronic money account corresponding to subscriber identification information of a remitter according to the remittance request signal among multiple pieces of previously-stored subscriber identification information according to users when the external relay server requests remittance completion confirmation in response to the request for the identification of the remittee and the currency exchange/remittance according to the remittance request signal, so that the subscriber identification information of each user can be used as a virtual electronic money account and electronic money can be conveniently exchanged/remitted between different countries by using the subscriber identification information.

Further, another object of the present invention is to provide a relay server and a method for processing remittance by the relay server, in which a country of the remittee is identified based on a remittance request signal and the amount of electronic money to be remitted according to the remittance request signal is exchanged for a currency unit of the country of the remittee based on exchange rate information of each country when an external electronic money server requests identification of the remittee and currency exchange/remittance according to the remittance request signal, and a remittance signal including the information on the amount of the exchanged currency related to the currency exchange is provided to an electronic money server in the relevant country, so that the subscriber identification information of each user can be used as a virtual electronic money account and electronic money can be conveniently exchanged/remitted between different countries by using the subscriber identification information.

### Technical solution

In accordance with an aspect of the present invention, there is provided a system for remitting electronic money, the system including: a service server for providing a remittance request signal according to a remittance request when receiving the remittance request including subscriber identification information of a remittee from a predetermined terminal apparatus; an electronic money server for managing an electronic money account corresponding to subscriber identification information of each user, and requesting identification of the remittee and currency exchange/remittance according to the remittance request signal when receiving the remittance request signal from the service server; and a relay server for when the relay server has been requested for the identification of the remittee and the currency exchange/remittance according to the remittance request signal by the electronic money server, identifying a country of the remittee based on the remittance request signal, and exchanging an amount of electronic money to be remitted according to the remittance request signal for a currency unit of the country of the remittee based on exchange rate information of each country and then providing the electronic money server in the relevant country with a remittance signal including information on an amount of the exchanged currency.

Preferably, the relay server is located in a roaming network.

Preferably, when receiving the remittance request from the terminal apparatus, the service server detects a communication network code corresponding to the remittee based on the subscriber identification information of the remittee included in the remittance request and then provides the electronic money server with the remittance request signal obtained by adding the communication network code to the remittance request.

Preferably, the service server provides and then notifies the terminal apparatus with/of completion of remitting electronic money to the remittee according to the remittance request signal in response to the remittance confirmation request when receiving the remittance confirmation request corresponding to the remittance request signal from the electronic money server.

In accordance with another aspect of the present invention, there is provided an electronic money server including: an electronic money account manager for managing an electronic money account corresponding to subscriber identification information of each user; and a server controller for requesting an external relay server for identification of a remittee and currency exchange/remittance according to a remittance request signal when receiving the remittance request signal including subscriber identification information of the remittee from an external service server.

Preferably, the remittance request signal includes at least one of: subscriber identification information of a remitter who makes a request for remitting electronic money to the remittee; the subscriber identification information of the remittee; a country code of the remittee; a communication network code corresponding to the remittee; and information on an amount of electronic money to be remitted.

Preferably, when the server controller is requested for remittance completion confirmation by the relay server in response to the request for the identification of the remittee and the currency exchange/remittance according to the remittance request signal, the server controller provides the service server with a remittance confirmation request which is made for notifying completion of remitting electronic money to a terminal apparatus corresponding to the subscriber identification information of the remitter, and reduces an amount of electronic money by the amount of electronic money, which has been remitted according to the remittance request signal, in a relevant electronic money account of the electronic money account manager corresponding to the subscriber identification information of the remitter.

Preferably, the server controller provides a predetermined terminal apparatus corresponding to the remittee according to a remittance signal with an electronic money remittance signal, which directs charging of electronic money corresponding to information on an amount of exchanged currency, when receiving the remittance signal including the information on the amount of the exchanged currency from the relay server.

Preferably, when receiving charging completion indicating charging of electronic money according to the amount of the exchanged currency in response to the electronic money remittance signal, the server controller provides the relay server with remittance completion corresponding to the remittance signal, and increases an amount of electronic money in accordance with the information on the amount of the exchanged currency in the relevant electronic money account of the electronic money account manager account corresponding to the subscriber identification information of the remittee.

In accordance with another aspect of the present invention, there is provided a relay server including: an exchange rate information storage unit for storing exchange rate information of each country; a currency exchange calculator for calculating an amount of exchanged currency based on the exchange rate information of each country; and a relay server controller for when the relay server is requested for identification of a remittee and currency exchange/remittance according to a remittance request signal by an external electronic money server, identifying a country of the remittee based on the remittance request signal, requesting the currency exchange calculator to exchange an amount of electronic money to be remitted according to the remittance request signal for a currency unit of the country of the remittee, and then providing an electronic money server in the relevant country with a remittance signal including the information on the amount of the exchanged currency related to the currency exchange.

Preferably, the relay server controller provides the electronic money server in the relevant country with the remittance signal including a subscriber identification number of the remittee and the information on the amount of the exchanged currency and then makes a request for remitting electronic money corresponding to the information on the amount of the exchanged currency to a terminal apparatus of the remittee, and provides the electronic money server with remittance completion confirmation which makes a request for notifying completion of remitting electronic money to a terminal apparatus of a remitter according to the remittance request signal when receiving remittance completion in response to the remittance signal.

In accordance with another aspect of the present invention, there is provided a method for remitting electronic money, the method including the steps of: providing a remittance request signal according to a remittance request by a service server when the remittance request including subscriber identification information of a remittee is received from a predetermined terminal apparatus; requesting identification of the remittee and currency exchange/remittance according to the remittance request signal by an electronic money server for managing an electronic money account corresponding to subscriber identification information of each user when the remittance request signal is received; identifying a country of the remittee based on the remittance request signal and then exchanging an amount of electronic money to be remitted according to the remittance request signal for a currency unit of the country of the remittee based on exchange rate information of each country by a relay server, when the identification of the remittee and the currency exchange/remittance according to the remittance request signal have been requested; and providing the electronic money server in the relevant country with a remittance signal including the information on the amount of the exchanged currency in response to the remittance request signal by the relay server.

Preferably, in the method, the step of providing the remittance request signal by the service server includes the sub-steps of: detecting a communication network code corresponding to the remittee based on the subscriber identification information of the remittee included in the remittance request received from the terminal apparatus; and providing the electronic money server with the remittance request signal obtained by adding the detected communication network code to the remittance request.

Preferably, the method further includes a step of transmitting a message, which notifies completion of remitting electronic money to the remittee, to the terminal apparatus in response to the remittance confirmation request by the service server when the remittance confirmation request corresponding to the remittance request signal is received from the electronic money server.

In accordance with another aspect of the present invention, there is provided a method for processing remittance by an electronic money server, the method including the steps of: determining whether a remittance request signal including subscriber identification information of the remittee is received from an external service server; requesting an external relay server for identification of a remittee and currency exchange/remittance according to the remittance request signal when the remittance request signal is received; determining whether remittance completion confirmation is requested by the external relay server in response to the request for the identification of the remittee and the currency exchange/remittance according to the remittance request signal; and reducing an amount of electronic money by the amount of the remitted electronic money in an electronic money account corresponding to subscriber identification information of a remitter according to the remittance request signal among multiple pieces of previously-stored subscriber identification information according to users when the remittance completion confirmation is requested.

Preferably, the remittance request signal includes at least one of: subscriber identification information of a remitter who makes a request for remitting electronic money to the remittee; the subscriber identification information of the remittee; a country code of the remittee; a communication network code corresponding to the remittee; and information on an amount of electronic money to be remitted.

Preferably, the method further includes a step of providing the service server with a remittance confirmation request which is made for notifying completion of remitting electronic money to a terminal apparatus corresponding to the subscriber identification information of the remitter when the remittance completion confirmation is requested.

Preferably, the method further includes the steps of: determining whether a remittance signal including information on an amount of exchanged currency is received from the relay server; and providing a predetermined terminal apparatus corresponding to the remittee according to the remittance signal with an electronic money remittance signal, which directs charging of electronic money in response to the information on the amount of the exchanged currency, when the remittance signal is received.

Preferably, the method further includes the steps of: determining whether charging completion indicating charging of electronic money according to the amount of the exchanged currency is received in response to the electronic money remittance signal; and providing the relay server with remittance completion corresponding to the remittance signal and increasing an amount of electronic money in accordance with the information on the amount of the exchanged currency in a relevant electronic money account of an electronic money account manager account corresponding to the subscriber identification information of the remittee, when the charging completion is received in response to the electronic money remittance signal.

In accordance with another aspect of the present invention, there is provided a method for processing remittance by a relay server, the method including the steps of: determining whether identification of a remittee and currency exchange/remittance according to a remittance request signal are requested by an external electronic money server; identifying a country of the remittee based on the remittance request signal and exchanging an amount of electronic money to be remitted according to the remittance request signal for a currency unit of the country of the remittee based on exchange rate information of each country, when the identification of the remittee and the currency exchange/remittance according to the remittance request signal are requested; and providing an electronic money server in the relevant country with a remittance signal including the information on the amount of the exchanged currency related to the currency exchange.

Preferably, the method further includes the steps of: determining whether remittance completion is received in response to the remittance signal, after providing the electronic money server in the relevant country with the remittance signal including a subscriber identification number of the remittee and the information on the amount of the exchanged currency; and providing the electronic money server with remittance completion confirmation which makes a request for notifying completion of remitting electronic money to a terminal apparatus corresponding to a remitter according to the remittance request signal when the remittance completion is received in response to the remittance signal.

### Advantageous Effects

As described above, by the system for remitting electronic money and the method for remitting electronic money according to the embodiments of the present invention, the electronic money server in each country may manage a virtual electronic money account corresponding to subscriber identification information of a terminal apparatus located in the relevant country, and when a terminal apparatus desiring remittance requests the remittance by inputting a country code of another terminal apparatus corresponding to a remittee of another country, subscriber identification information of the remittee and information on the amount of electronic money to be remitted, the relay server may exchange the amount of electronic money to be remitted for the currency of another country of the remittee based on an exchange rate of another country of the remittee, and then may cause both the terminal apparatus of the relevant remittee and an electronic money account stored an electronic money server corresponding to the terminal apparatus of the relevant remittee to increase the amount of electronic money by that of the exchanged currency.

Therefore, by the system for remitting electronic money and the method for remitting electronic money according to the embodiments of the present invention, a remitter can conveniently exchange/remit electronic money by using a mobile phone number of a remittee terminal apparatus in another country, and thus users can have great convenience to exchange/remit electronic money between different countries, so that it is possible to resolve conventional distrust which may occur when a user has financial dealings (e.g. remittance) with an acquaintance of another country through a poor bank network.

### BRIEF DESCRIPTION OF THE DRAWINGS

The foregoing and other objects, features and advantages of the present invention will become more apparent from the following detailed description when taken in conjunction with the accompanying drawings in which:

FIG. 1 is a block diagram illustrating the control structure of a system for remitting electronic money according to an embodiment of the present invention;

FIG. 2 is a block diagram illustrating the control structure of an electronic money server according to an embodiment of the present invention;

FIG. 3 is a block diagram illustrating the control structure of a relay server according to an embodiment of the present invention;

FIG. 4 is a signal flow diagram showing the control flow of a method for remitting electronic money according to an embodiment of the present invention;

FIG. 5 is a flow chart showing the control flow of a method for remitting electronic money by an electronic money server according to an embodiment of the present invention; and

FIG. 6 is a flow chart showing the control flow of a method for remitting electronic money by a relay server according to an embodiment of the present invention.

### BEST MODE

### Mode for Invention

Hereinafter, preferred embodiments of the present invention will be described in detail with reference to the accompanying drawings. However, the present invention is not limited or restricted by preferred embodiments thereof. Also, in the following description and drawings, the same reference numerals are used to designate the same or similar components, and so repetition of the description on the same or similar components will be omitted.

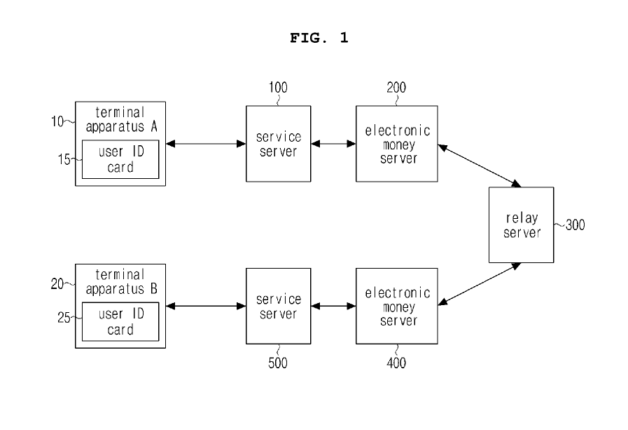

FIG. 1 is a block diagram illustrating the control structure of a system for remitting electronic money according to a first embodiment of the present invention.

Referring to FIG. 1, a system for remitting electronic money according to the first embodiment of the present invention includes: a service server 100 for providing a remittance request signal according to a remittance request when receiving the remittance request including subscriber identification information of a remittee from a predetermined terminal apparatus (e.g. terminal apparatus A 10); an electronic money server 200 for managing an electronic money account corresponding to the subscriber identification information of each user, and requesting identification of the remittee and currency exchange/remittance according to the remittance request signal when receiving the remittance request signal from the service server 100; and a relay server 300 which when it has been requested for the identification of the remittee and the currency exchange/remittance according to the remittance request signal by the electronic money server 200, identifies a country of the remittee based on the remittance request signal, exchanges the amount of electronic money to be remitted according to the remittance request signal for the currency of the country of the remittee based on exchange rate information of each country, and then provides an electronic money server 400 in the country of the remittee with a remittance signal including the information on the amount of the exchanged currency.

Herein, in the configuration of the system of remitting electronic money, terminal apparatus A 10, the service server 100 and the electronic money server 200 are located in a country named A, and terminal apparatus B 20, the service server 500 and the electronic money server 400 are located in a country named B.

Terminal apparatus A 10 will be described as follows. It is desirable that terminal apparatus A 10 is embedded with an electronic money card for storing electronic money. This electronic money card, which is in the form of a smart card, may be a user identification card 15 such as a SIM (Subscriber Identification Module) card or a USIM (Universal Subscriber Identification Module) card.

In this case, terminal apparatus A 10 is desirably in the form of a terminal supporting mobile communication, and has unique subscriber identification information assigned to itself. Also, the unique subscriber identification information is desirably a subscriber identification number (i.e. a Mobile Identification Number (MIN)) such as a mobile phone number.

Therefore, when a user of terminal apparatus A 10 intends to remit electronic money of terminal apparatus A 10 to terminal apparatus B 20 corresponding to another user of another country (e.g. country B), terminal apparatus A 10 provides, by the input of the user of terminal apparatus A 10, the service server 100 with a remittance request including at least one of subscriber identification information of terminal apparatus A 10 corresponding to a remitter, a country code (i.e. a Mobile Country Code (MCC)) of country B, subscriber identification information of terminal apparatus B 20 corresponding to a remittee, and information on the amount of electronic money to be remitted.

At this time, terminal apparatus A 10 may provide the remittance request to the service server 100 through an Internet network, and may provide the remittance request in various methods, such that terminal apparatus A 10 may provide the remittance quest to the service server 100 by attempting to perform transmission through a combination of keys corresponding to the country code of country B, the subscriber identification information (i.e. a subscriber identification number) of terminal apparatus B 20, and the amount of electronic money to be remitted.

The service server 100 and the service server 500 are just located in different countries, respectively, and perform the same function or corresponding functions. Also, it is desirable that the service server 100 and the service server 500 are servers of communication service providers that provide a mobile communication service or a wired communication service. Hereinafter, the following explanation will be given by describing the service server 100.

When receiving the remittance request including the subscriber identification information of the remittee from terminal apparatus A 10, the service server 100 provides the electronic money server 200 with a remittance request signal according to the remittance request.

At this time, when receiving the remittance request including the subscriber identification information of terminal apparatus A 10 corresponding to the remitter, the country code of the country (e.g. country B) and the subscriber identification information of the remittee (e.g. terminal apparatus B 20), and the information on the amount of electronic money to be remitted, the service server 100, desirably, detects a communication network code (i.e. a Mobile Network Code (MNC)) corresponding to the remittee based on the subscriber identification information of the remittee (e.g. terminal apparatus B 20), and then provides the electronic money server 200 with the remittance request signal obtained by adding the detected communication network code to the remittance request. In this case, the communication network code may be an IDentification (ID) of a mobile communication service provider or an ID of a network in an area where terminal apparatus B 20 corresponding to the remittee is located.

Namely, when receiving the remittance request, the service server 100 provides the electronic money server 200 with the remittance request signal including the communication network code, which has been detected in response to the remittee based on the subscriber identification information of the remittee (e.g. terminal apparatus B 20), the subscriber identification information of the remitter (e.g. terminal apparatus A 10), the country code of the country (e.g. country B) and the subscriber identification information of the remittee (e.g. terminal apparatus B 20), and the information on the amount of electronic money to be remitted.

Next, when receiving a remittance confirmation request corresponding to the remittance request signal from the electronic money server 200, the service server 100 provides and then notifies terminal apparatus A 10 corresponding to the remitter with/of the completion of remitting electronic money to the remittee (e.g. terminal apparatus B 20) according to the remittance request signal in response to the remittance confirmation request. Therefore, the terminal apparatus (e.g. terminal apparatus A 10) corresponding to the remitter may reduce electronic money of itself by the amount of the remitted electronic money.

In this case, it is desirable that a scheme, in which the service server 100 notifies terminal apparatus A 10 of the completion of remitting electronic money, includes the form of a message for user identification, such as an SMS (Short Message Service) and/or an MMS (Multimedia Message Service).

Meanwhile, when receiving an electronic money remittance signal, which requests a predetermined terminal apparatus (e.g. terminal apparatus A 10) to charge electronic money according to predetermined information on the amount of the exchanged currency, from the electronic money server 200, the service server 100 may provide the relevant terminal apparatus (e.g. terminal apparatus A 10) with an electronic money charging signal, which directs the charging of electronic money according to the information on the amount of the exchanged currency, in response to the received electronic money remittance signal. Therefore, the terminal apparatus (e.g. terminal apparatus A 10) may charge electronic money of itself according to the electronic money charging signal, and then increase the amount of electronic money of itself.

Next, when the relevant terminal apparatus (e.g. terminal apparatus A 10) notifies the service server 100 of the completion of charging electronic money as a response, the service server 100 may notify the electronic money server 200 of the completion of charging electronic money in response to the electronic money remittance signal.

The electronic money server 200 and the electronic money server 400, which are just located in different countries, perform the same function or corresponding functions. The following explanation will be given by describing the electronic money server 200.

The electronic money server 200 manages an electronic money account corresponding to subscriber identification information of each user, and requests the relay server 300 for identification of a remittee and currency exchange/remittance according to a remittance request signal when receiving the remittance request signal from the service server 100.

Next, when receiving remittance completion confirmation, which makes a request for notifying the completion of remitting electronic money to a predetermined terminal apparatus (e.g. terminal apparatus A 10) corresponding to a remitter according to the remittance request signal, from the relay server 300 in response to the request for the identification of the remittee and the currency exchange/remittance according to the remittance request signal, the electronic money server 200 provides the service server 100 with a remittance confirmation request according to the reception of the remittance completion confirmation. Therefore, the electronic money server 200 causes the service server 100 to provide and then notify the relevant terminal apparatus (e.g. terminal apparatus A 10) with/of the completion of remitting electronic money to the remittee (e.g. terminal apparatus B 20) according to the remittance request of the remitter.

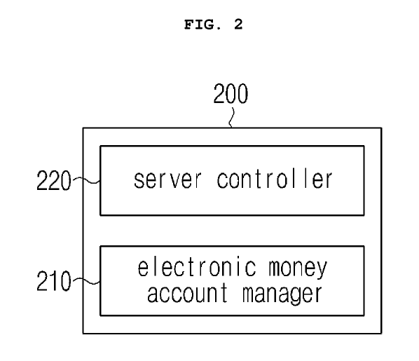

Hereinafter, the electronic money server 200 according to an embodiment of the present invention will be described in more detail with reference to FIG. 2.

The electronic money server 200 according to an embodiment of the present invention includes an electronic money account manager 210 for managing an electronic money account corresponding to subscriber identification information of each user, and a server controller 220 which when receiving a remittance request signal including subscriber identification information of a remittee from an external service server 100, requests an external relay server 300 for identification of the remittee and currency exchange/remittance according to the received remittance request signal.

As described above, the remittance request signal from the service server 100 includes the subscriber identification information of the remitter (e.g. terminal apparatus A 10), the communication network code of the remittee (e.g. terminal apparatus B 20), the country code of the country (e.g. country B) and the subscriber identification information of the remittee, and the information on the amount of electronic money to be remitted.

The electronic money account manager 210 manages an electronic money account corresponding to subscriber identification information of each user. Namely, the electronic money account manager 210 stores the electronic money account of each user, and may increase or reduce and then change the amount of electronic money in the electronic money account of the relevant user under the increase or reduction control of the server controller 220.

When receiving a remittance request signal from the service server 100, the server controller 220 requests the external relay server 300 for identification of a remittee and currency exchange/remittance according to the received remittance request signal. At this time, when receiving the remittance request signal, the server controller 220 first determines whether there is electronic money whose amount is equal to or greater than the amount of electronic money to be remitted in a relevant electronic money account stored in the electronic money account manager 210 based on subscriber identification information of a remitter (e.g. terminal apparatus A 10). When there is no electronic money whose amount is equal to or greater than the amount of electronic money to be remitted in the relevant electronic money account, the server controller 220 may reject the remittance request signal at this time or may request the service server 100 to notify inexecutable remittance to the relevant remitter (e.g. terminal apparatus A 10).

Next, when the electronic money server 200 has requested the relay server 300 for the identification of the remittee and the currency exchange/remittance according to the remittance request signal and is requested for remittance completion confirmation by the relay server 300 in response to the above request, the server controller 220 provides the service server 100 with a remittance confirmation request which is made for notifying the completion of remitting electronic money to a relevant terminal apparatus (e.g. terminal apparatus A 10) corresponding to the subscriber identification information of the remitter. Then, the server controller 220 may reduce the amount of electronic money by that of electronic money remitted according to the remittance request signal in the relevant electronic money account of the electronic money account manager 210 corresponding to the subscriber identification information of the remitter.

It goes without saying that the server controller 220 may reduce the amount of electronic money by that of the remitted electronic money in the electronic money account corresponding to the remitter (e.g. terminal apparatus A 10) of the electronic money account manager 210 simultaneously with directly providing an electronic money reduction signal to the terminal apparatus (e.g. terminal apparatus A 10) of the relevant remitter.

Meanwhile, a description will be made below of a case where a terminal apparatus (e.g. terminal apparatus B 20) in country B requests remittance, with a terminal apparatus (e.g. terminal apparatus A 10) in country A as a remittee. First, the terminal apparatus (e.g. terminal apparatus B 20) in country B makes a request for remitting electronic money to the remittee terminal apparatus (e.g. terminal apparatus A 10) in country A. Therefore, when receiving a remittance signal including information on the amount of the exchanged currency from the relay server 300, the server controller 220 may provide the service server 100 with an electronic money remittance signal which causes a predetermined terminal apparatus (e.g. terminal apparatus A 10) corresponding to the remittee according to the received remittance signal to charge electronic money according to the information on the amount of the exchanged currency. Therefore, the service server 100 may provide the relevant terminal apparatus (e.g. terminal apparatus A 10) with an electronic money charging signal, which directs the charging of electronic money according to the information on the amount of the exchanged currency, in response to the electronic money remittance signal.

It goes without saying that when receiving a remittance signal including the information on the amount of the exchanged currency from the relay server 300, the server controller 220 may directly provide a terminal apparatus (e.g. terminal apparatus A 10) of a remittee with an electronic money charging signal which directs the charging of electronic money, and then may cause the predetermined terminal apparatus (e.g. terminal apparatus A 10) corresponding to the remittee according to the remittance signal to charge stored electronic money of itself according to the information on the amount of the exchanged currency.

Next, when receiving the charging completion, which indicates electronic money has been charged by the amount of the exchanged currency, in response to the electronic money remittance signal, the server controller 220 may provide the relay server 300 with remittance completion corresponding to the remittance signal, and may increase the amount of electronic money in response to the information on the amount of the exchanged currency in a relevant electronic money account of the electronic money account manager 210 corresponding to the subscriber identification information of the remittee (e.g. terminal apparatus A 10)

Referring again to FIG. 1, when the relay server 300 has been requested for the identification of the remittee and the currency exchange/remittance according to the remittance request signal by the electronic money server 200, the relay server 300 identifies a country of the remittee based on the remittance request signal, exchanges the amount of electronic money to be remitted according to the remittance request signal for the currency of the country (e.g. country B) of the remittee (e.g. terminal apparatus B 20) based on exchange rate information of each country, and then provides the electronic money server 400 in the country of the remittee with a remittance signal including information on the amount of the exchanged currency.

In this case, it is desirable that the relay server 300 is located in a roaming network (not shown) which can support roaming between countries.

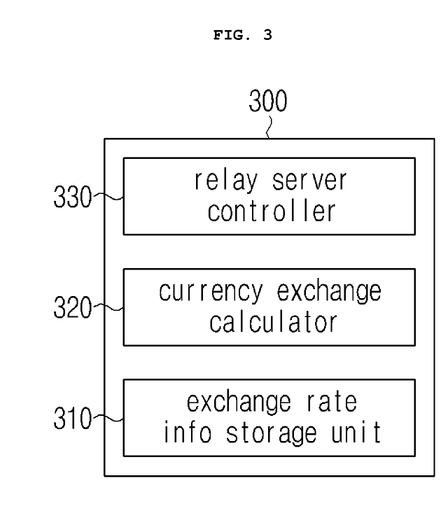

Hereinafter, a detailed configuration of the relay server 300 will be described according to an embodiment of the present invention with reference to FIG. 3.

The relay server 300 according to an embodiment of the present invention includes an exchange rate information storage unit 310 for storing exchange rate information of each country, a currency exchange calculator 320 for calculating the amount of exchanged currency based on the exchange rate information of each country, and a relay server controller 330, which when the relay server 300 is requested for identification of a remittee and currency exchange/remittance according to a remittance request signal by the external electronic money server 200, identifies a country of the remittee based on the remittance request signal, requests the currency exchange calculator 320 to exchange the amount of electronic money to be remitted according to the remittance request signal for the currency of the country of the remittee, and then provides the electronic money server 400 in the country of the remittee with a remittance signal including information on the amount of the exchanged currency according to the above request.

It is desirable that the exchange rate information storage unit 310, which is a storage unit for storing exchange rate information of each country, continuously manages and updates in real-time the exchange rate information of each country stored therein.

The currency exchange calculator 320 calculates the amount of exchanged currency based on the exchange rate information of each country. Namely, when a country of the remittee has been identified by the relay server controller 330, the currency exchange calculator 320 may calculate the amount of the currency of the relevant country, for which the amount of electronic money to be remitted is exchanged, based on the exchange rate information of the relevant country among multiple pieces of the exchange rate information according to the countries stored in the exchange rate information storage unit 310.

When the relay server 300 has been requested for identification of a remittee and currency exchange/remittance according to a remittance request signal by the electronic money server 200, the relay server controller 330 identifies a country of the remittee based on the remittance request signal. Namely, the relay server controller 330 may detect a country code of the remittee included in the remittance request signal, and then identify a country (e.g. country B) of the remittee.

Then, the relay server controller 330 provides the currency exchange calculator 320 with information on the amount of electronic money to be remitted and the identified country (e.g. country B) according to the remittance request signal, and then requests the currency exchange calculator 320 to exchange the amount of electronic money to be remitted for the currency of the country (e.g. country B) of the remittee. Next, when receiving information on the amount of the exchanged currency from the currency exchange calculator 320 in response to the above request, the relay server controller 330 provides the electronic money server 400 in the relevant country (e.g. country B) with a remittance signal including the information on the amount of the exchanged currency.

In this case, the remittance signal may include at least one of information on the amount of the exchanged currency, and a subscriber identification number and a communication network code of the remittee (e.g. terminal apparatus B 20).

As described above, the relay server controller 330 provides the remittance signal to the electronic money server 400 in the relevant country (e.g. country B), and then requests the electronic money server 400 to remit electronic money corresponding to the information on the amount of the exchanged currency to a predetermined terminal apparatus (e.g. terminal apparatus B 20) corresponding to the remittee. Next, when receiving remittance completion from the electronic money server 400 in response to the remittance signal, the relay server controller 330 provides and then requests the electronic money server 200 with/for remittance completion confirmation which makes a request for notifying the completion of remitting electronic money to a predetermined terminal apparatus (e.g. terminal apparatus A 10) corresponding to a remitter according to the remittance request signal.

Namely, when receiving the remittance completion from the electronic money server 400 in response to the remittance signal, by requesting the electronic money server 200 for remittance completion confirmation which makes a request for notifying the completion of remitting electronic money to a predetermined terminal apparatus (e.g. terminal apparatus A 10) corresponding to the remitter according to the remittance request signal, the relay server controller 330 may provide the service server 100 with a remittance confirmation request which requests the electronic money server 200 to notify the completion of remitting electronic money to a relevant terminal apparatus (e.g. terminal apparatus A 10) corresponding to the subscriber identification information of the remitter.

As described above, in the system for remitting electronic money according to an embodiment of the present invention, the electronic money servers 200 and 400 in the relevant countries manage a virtual electronic money account corresponding to subscriber identification information of each terminal apparatus, and when a terminal apparatus desiring remittance requests the remittance by inputting a country code of another terminal apparatus corresponding to a remittee of another country, subscriber identification information of the remittee and information on the amount of electronic money to be remitted, the relay server 300 exchanges the amount of electronic money to be remitted for the currency of another country of the remittee based on an exchange rate of another country of the remittee, and then causes both the terminal apparatus of the relevant remittee and an electronic money account corresponding to the terminal apparatus of the relevant remittee to increase the amount of electronic money by that of the exchanged currency.

Therefore, by the system for remitting electronic money according to an embodiment of the present invention, a remitter can conveniently exchange/remit electronic money by using a mobile phone number of a remittee terminal apparatus in another country, and thus users can have great convenience to exchange/remit electronic money between different countries, so that it is possible to resolve conventional distrust which may occur when a user has financial dealings (e.g. remittance) with an acquaintance of another country through a poor bank network.

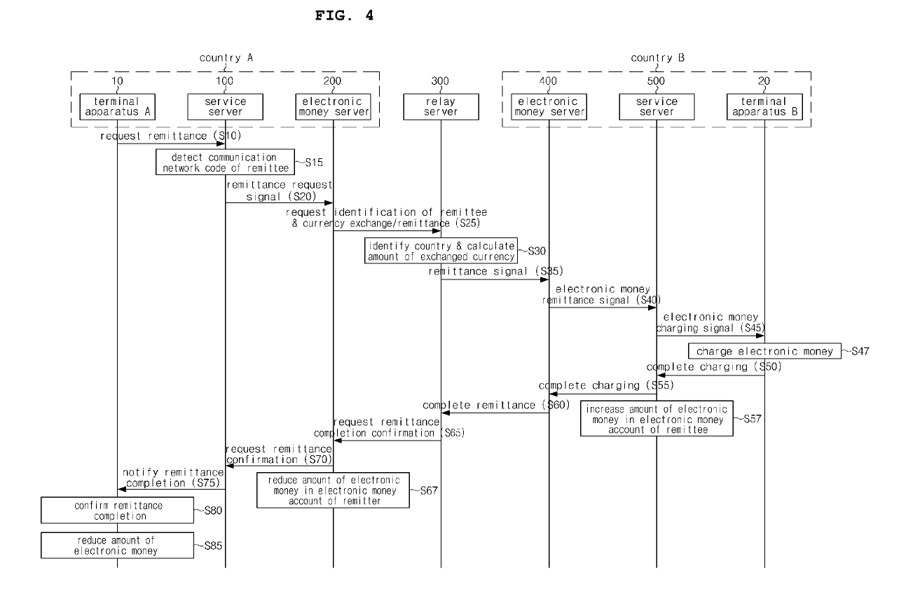

Hereinafter, the control flow of a method for remitting electronic money according to an embodiment of the present invention configured as described above will be described with reference to FIGS. 4 to 6. Herein, for the convenience of the description, the configurations shown in FIGS. 1 to 3 as described above will be described with reference to corresponding reference numerals.

A method for remitting electronic money according to an embodiment of the present invention will be described with reference to FIG. 4.

In the configuration according to an embodiment of the present invention, terminal apparatus A 10, the service server 100 and the electronic money server 200 are located in country A, and terminal apparatus B 20, the service server 500 and the electronic money server 400 are located in country B.

Also, a description will be made of an example where a user of terminal apparatus A 10 intends to remit electronic money of terminal apparatus A 10 to terminal apparatus B 20 corresponding to another user of another country (e.g. country B).

Terminal apparatus A 10 located in country A provides, by the input of a user of terminal apparatus A 10, the service server 100 with a remittance request including at least one of subscriber identification information of terminal apparatus A 10 corresponding to a remitter, subscriber identification information of terminal apparatus B 20 corresponding to a remittee, a country code (i.e. a Mobile Country Code (MCC)) of country B in which the remittee is located, and information on the amount of electronic money to be remitted (S10). The subscriber identification information is desirably a subscriber identification number (i.e. a Mobile Identification Number (MIN)) such as a mobile phone number.

When receiving the remittance request from terminal apparatus A 10, the service server 100 detects a communication network code corresponding to the remittee based on the subscriber identification information of the remittee (e.g. terminal apparatus B 20) included in the remittance request (S15), and then provides the electronic money server 200 with a remittance request signal obtained by adding the detected communication network code to the remittance request (S20). In this case, the communication network code (i.e. a Mobile Network Code (MNC)) may be an IDentification (ID) of a mobile communication service provider or an ID of a network in an area where terminal apparatus B 20 corresponding to the remittee is located. Namely, when receiving the remittance request, the service server 100 provides the electronic money server 200 with the remittance request signal including the communication network code, which has been detected in response to the remittee based on the subscriber identification information of the remittee (e.g. terminal apparatus B 20), the subscriber identification information of the remitter (e.g. terminal apparatus A 10), the country code of the country (e.g. country B) and the subscriber identification information of the remittee (e.g. terminal apparatus B 20), and the information on the amount of electronic money to be remitted.

The electronic money server 200, which is located in country A and manages an electronic money account corresponding to the subscriber identification information of each user of country A, requests the relay server 300 for identification of the remittee and currency exchange/remittance according to the remittance request signal when receiving the remittance request signal from the service server 100 (S25). In this case, it is desirable that the relay server 300 is located in a roaming network.

When it has been requested for the identification of the remittee and the currency exchange/remittance according to the remittance request signal by the electronic money server 200, the relay server 300 identifies a country (e.g. country B) of the remittee based on the remittance request signal, and exchanges the amount of electronic money to be remitted according to the remittance request signal for the currency of country B of the remittee (e.g. terminal apparatus B 20) based on exchange rate information of each country (S30). Then, the relay server 300 provides the electronic money server 400 in country B with a remittance signal including information on the amount of the exchanged currency for which the amount of electronic money to be remitted is exchanged (S35).

Next, when receiving the remittance signal including information on the amount of the exchanged currency from the relay server 300, the electronic money server 400 in country B may provide the service server 500 in country B with an electronic money remittance signal which causes terminal apparatus B 20 corresponding to the remittee according to the remittance signal to charge electronic money according to the information on the amount of the exchanged currency (S40). Then, the service server 500 may provide terminal apparatus B 20 with an electronic money charging signal, which directs the charging of electronic money according to the information on the amount of the exchanged currency, in response to the electronic money remittance signal (S45). It goes without saying that when receiving a remittance signal including information on the amount of the exchanged currency from the relay server 300, the electronic money server 400 may directly provide a terminal apparatus (e.g. terminal apparatus B 20) of a remittee with an electronic money charging signal which directs the charging of electronic money according to the remittance signal.

Thereafter, terminal apparatus B 20 of the remittee, which receives the electronic money charging signal, charges electronic money of a user identification card 25 in such a manner as to increase the amount of electronic money of the user identification card 25 by the amount corresponding to the information on the amount of the exchanged currency according to the electronic money charging signal (S47). Then, terminal apparatus B 20 transmits charging completion to the service server 500 in response to the electronic money charging signal (S50).

Next, when receiving the charging completion in response to the electronic money charging signal in step S45, the service server 500 may transmit the charging completion to the electronic money server 400 in response to the relevant electronic money remittance signal (S55).

When receiving the charging completion, which indicates that electronic money has been charged by the amount of the exchanged currency, from the service server 500 in response to the electronic money remittance signal, the electronic money server 400 provides the relay server 300 with remittance completion corresponding to the remittance signal in step S35 (S60). Also, the electronic money server 400, which is located in country B and manages an electronic money account corresponding to the subscriber identification information of each user of country B, may increase the amount of electronic money in response to the information on the amount of the exchanged currency in an electronic money account corresponding to the subscriber identification information of terminal apparatus B 20 corresponding to the remittee (S57). In this case, it is possible to interchange the order of executions of steps S57 and S60, or it is possible to simultaneously perform steps S57 and S60.

When receiving remittance completion from the electronic money server 400 in response to the remittance signal, the relay server 300 provides and then requests the electronic money server 200 with/for remittance completion confirmation which makes a request for notifying the completion of remitting electronic money to terminal apparatus A 10 of a remitter according to the relevant remittance request signal received in step S25 (S65).

Then, the electronic money server 200, which has been requested for the remittance completion confirmation, the terminal apparatus B 20 provides the service server 100 with remittance completion confirmation which makes a request for notifying the completion of remitting electronic money to terminal apparatus A 10 corresponding to the subscriber identification information of the remitter (S70). Next, the electronic money server 200 may reduce the amount of electronic money by that of the electronic money, which has been remitted according to the remittance request signal, in an electronic money account corresponding to the subscriber identification information of terminal apparatus A 10 corresponding to the remitter (S67). In this case, it is possible to interchange the order of executions of steps S67 and S70, or it is possible to simultaneously perform steps S67 and S70.

It goes without saying that the electronic money server 200 may reduce the amount of electronic money by that of the remitted electronic money in the electronic money account corresponding to the remitter (e.g. terminal apparatus A 10), without providing the remittance confirmation request to the service server 100, simultaneously with directly providing an electronic money reduction signal to terminal apparatus A 10 of the relevant remitter.

Next, when receiving a remittance confirmation request corresponding to the remittance request signal from the electronic money server 200, the service server 100 provides and then notifies terminal apparatus A 10 corresponding to the remitter with/of the completion of remitting electronic money to the remittee (e.g. terminal apparatus B 20) according to the remittance request signal in response to the remittance confirmation request (S75). Then, terminal apparatus A 10 corresponding to the remitter may cause the remitter to confirm the remittance completion by displaying information on the remittance completion (S80), and may reduce the amount of electronic money of terminal apparatus A 10 itself by that of the remitted electronic money (S85).

In this case, it is desirable that a scheme, in which the service server 100 notifies terminal apparatus A 10 of the completion of remitting electronic money, includes the form of a message for user identification, such as an SMS (Short Message Service) and/or an MMS (Multimedia Message Service).

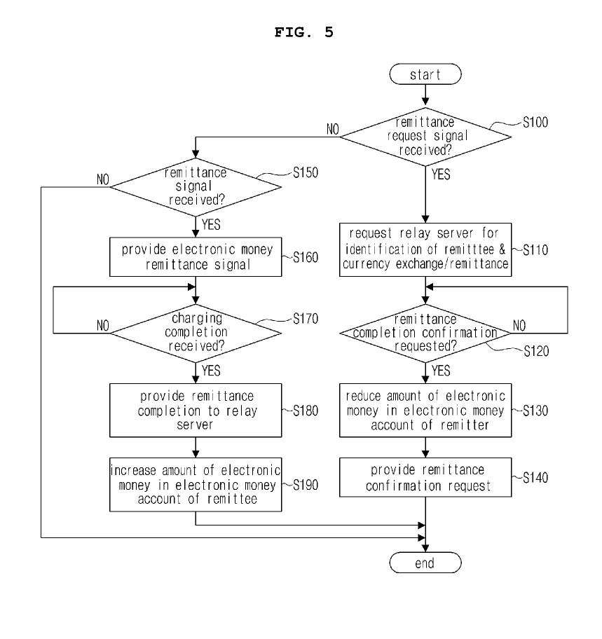

Hereinafter, a method for processing remittance by an electronic money server according to an embodiment of the present invention will be described with reference to FIG. 5. The electronic money server 200 and the electronic money server 400, which are just located in different countries, perform the same function or corresponding functions. The following explanation will be given by describing the electronic money server 200.

The electronic money server 200 according to an embodiment of the present invention determines whether a remittance request signal is received from the service server 100 (S100). When the remittance request signal is received from the service server 100, the electronic money server 200 requests the external relay server 300 for identification of a remittee and currency exchange/remittance according to the received remittance request signal (S110). Herein, the remittance request signal includes subscriber identification information of a remitter (e.g. terminal apparatus A 10), a communication network code of a remittee (e.g. terminal apparatus B 20), a country code of a relevant country (e.g. country B) and subscriber identification information of the remittee, and information on the amount of electronic money to be remitted.

At this time, when receiving the remittance request signal, the electronic money server 200 first determines whether there is electronic money whose amount is equal to or greater than the amount of electronic money to be remitted in a relevant electronic money account, which has previously been stored, based on the subscriber identification information of terminal apparatus A 10 corresponding to the remitter. When there is no electronic money whose amount is equal to or greater than the amount of electronic money to be remitted in the relevant electronic money account, the server controller 220 may reject the remittance request signal at this time or may request the service server 100 to notify inexecutable remittance to relevant remitter terminal apparatus A 10.

After requesting the relay server 300 for the identification of the remittee and the currency exchange/remittance according to the remittance request signal, the electronic money server 200 determines whether it is requested for remittance completion confirmation by the relay server 300 in response to the above request (S120). When it is requested for remittance completion confirmation by the relay server 300, the electronic money server 200 may reduce the amount of electronic money by the amount of electronic money remitted according to the remittance request signal in an electronic money account corresponding to the subscriber identification information of remitter terminal apparatus A 10 (S130). Also, when it is requested for the remittance completion confirmation by the relay server 300, the electronic money server 200 provides the service server 100 with a remittance confirmation request which is made for notifying the completion of remitting electronic money according to the remittance request signal to terminal apparatus A 10 corresponding to the subscriber identification information of the remitter (S140).

It goes without saying that when the electronic money server 200 is requested for the remittance completion confirmation by the relay server 300, it may reduce the amount of electronic money by that of the remitted electronic money in the electronic money account corresponding to terminal apparatus A 10 of the remitter simultaneously with directly providing an electronic money reduction signal to terminal apparatus A 10 of the relevant remitter.

Meanwhile, it is desirable that when the result of determination in step S100 shows that the remittance request signal is not received, the electronic money server 200 determines whether remittance is generated from another country (e.g. country B). Namely, a description will be made below of a case where a terminal apparatus (e.g. terminal apparatus B 20) in country B requests remittance, with a terminal apparatus (e.g. terminal apparatus A 10) in country A as a remittee. First, the terminal apparatus (e.g. terminal apparatus B 20) in country B makes a request for remitting electronic money to the remittee terminal apparatus (e.g. terminal apparatus A 10) in country A. Therefore, the relay server 300 may provide a remittance signal to the electronic money server 200 in country A. In this case, the remittance signal may include at least one of information on the amount of the exchanged currency, and a subscriber identification number and a communication network code of the remittee (e.g. terminal apparatus B 20).

Next, when the result of determination in step S100 shows that the remittance request signal is not received, the electronic money server 200 determines whether a remittance signal is received from the relay server 300 (S150). When the remittance signal is received from the relay server 300, the electronic money server 200 may provide the service server 100 with an electronic money remittance signal which causes terminal apparatus A 10 corresponding to the remittee according to the received remittance signal to charge electronic money according to the information on the amount of the exchanged currency (S160). Therefore, the service server 100 may provide the relevant terminal apparatus (e.g. terminal apparatus A 10) with an electronic money charging signal, which directs the charging of electronic money according to the information on the amount of the exchanged currency, in response to the electronic money remittance signal.

It goes without saying that when receiving a remittance signal including the information on the amount of the exchanged currency from the relay server 300, the electronic money server 200 may directly provide a terminal apparatus (e.g. terminal apparatus A 10) of a remittee with an electronic money charging signal which directs the charging of electronic money, and then may cause the terminal apparatus (e.g. terminal apparatus A 10) of the remittee to charge stored electronic money of itself according to the information on the amount of the exchanged currency according to the remittance signal.

Next, the electronic money server 200 determines whether the charging completion, which indicates electronic money has been charged by the amount of the exchanged currency, is received in response to the electronic money remittance signal in step S160 (S170). When the charging completion is received in response to the electronic money remittance signal, the electronic money server 200 provides the relay server 300 with remittance completion corresponding to the remittance signal (S180). Also, when the charging completion is received in response to the electronic money remittance signal, the electronic money server 200 may increase the amount of electronic money in response to the information on the amount of the exchanged currency in an electronic money account corresponding to the subscriber identification information of remittee terminal apparatus A 10 (S190).

In this case, it is possible to interchange the order of executions of steps S180 and S190, or it is possible to simultaneously perform steps S180 and S190.

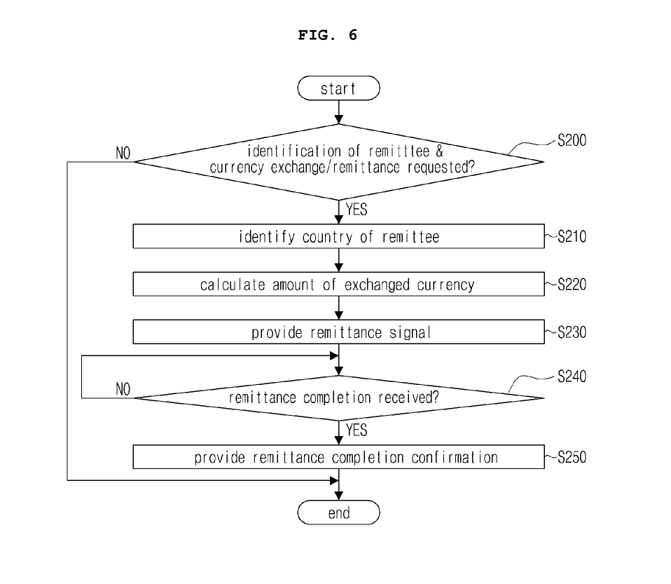

Hereinafter, a method for processing remittance by the relay server 300 according to an embodiment of the present invention will be described in more detail with reference to FIG. 6.

Referring to FIG. 6, the relay server 300 determines whether the relay server 300 has been requested for identification of a remittee and currency exchange/remittance according to a remittance request signal by the electronic money server 200 located in a predetermined country (e.g. country A) (S200). It goes without saying that the remittance request signal as described above includes subscriber identification information of a remitter (e.g. terminal apparatus A 10), a communication network code of a remittee (e.g. terminal apparatus B 20), a country code of a relevant country (e.g. country B) and subscriber identification information of the remittee, and information on the amount of electronic money to be remitted.

Next, when it has been requested for identification of a remittee and currency exchange/remittance according to a remittance request signal by the electronic money server 200, the relay server 300 identifies a country of the remittee based on the remittance request signal (S210). Namely, the relay server controller 330 of the relay server 300 may detect a country code of the remittee included in the remittance request signal, and then identify a country (e.g. country B) of the remittee.

Then, the relay server 300 calculates the amount of the currency of the country (e.g. country B) of the remittee, for which the amount of electronic money to be remitted is exchanged, based on information on the amount of electronic money to be remitted and the identified country (e.g. country B) according to the remittance request signal (S220). Namely, the currency exchange calculator 320 of the relay server 300 calculates the amount of the currency of the country of the remittee, for which the amount of electronic money to be remitted is exchanged, based on the information on the amount of electronic money to be remitted, the country (e.g. country B) of the remittee, and previously-stored exchange rate information of each country.

Next, the relay server 300 provides the electronic money server 400 in the country (e.g. country B) corresponding to the remittee with a remittance signal including the information on the amount of the exchanged currency as calculated above (S230). In this case, the remittance signal may include at least one of information on the amount of the exchanged currency, and a subscriber identification number and a communication network code of the remittee (e.g. terminal apparatus B 20). As described above, the relay server 300 may provide the remittance signal to the electronic money server 400 in the relevant country (e.g. country B), and then request the electronic money server 400 to remit electronic money corresponding to the information on the amount of the exchanged currency to a predetermined terminal apparatus (e.g. terminal apparatus B 20) corresponding to the remittee.

Thereafter, the relay server 300 determines whether remittance completion is received from the electronic money server 400 in response to the remittance signal (S240). When the remittance completion is received from the electronic money server 400 in response to the remittance signal, the relay server 300 provides and then requests the electronic money server 200 with/for remittance completion confirmation which makes a request for notifying the completion of remitting electronic money to terminal apparatus A 10 corresponding to a remitter according to the remittance request signal (S250).

Namely, when the remittance completion is received from the electronic money server 400 in response to the remittance signal, by requesting the electronic money server 200 for remittance completion confirmation which makes a request for notifying the completion of remitting electronic money to a predetermined terminal apparatus (e.g. terminal apparatus A 10) corresponding to the remitter according to the remittance request signal, the relay server controller 330 of the relay server 300 may provide the service server 100 with a remittance confirmation request which requests the electronic money server 200 to notify the completion of remitting electronic money to a relevant terminal apparatus (e.g. terminal apparatus A 10) corresponding to the subscriber identification information of the remitter.

As described above, in the method for remitting electronic money according to an embodiment of the present invention, the electronic money servers 200 and 400 in the relevant countries manage a virtual electronic money account corresponding to subscriber identification information of each terminal apparatus, and when a terminal apparatus desiring remittance requests the remittance by inputting a country code of another terminal apparatus corresponding to a remittee of another country, subscriber identification information of the remittee and information on the amount of electronic money to be remitted, the relay server 300 exchanges the amount of electronic money to be remitted for the currency of another country of the remittee based on an exchange rate of another country of the remittee, and then causes both the terminal apparatus of the relevant remittee and an electronic money account corresponding to the terminal apparatus of the relevant remittee to increase the amount of electronic money by that of the exchanged currency.

Therefore, by the method for remitting electronic money according to an embodiment of the present invention, a remitter can conveniently exchange/remit electronic money by using a mobile phone number of a remittee terminal apparatus in another country, and thus users can have great convenience to exchange/remit electronic money between different countries, so that it is possible to resolve conventional distrust which may occur when a user has financial dealings (e.g. remittance) with an acquaintance of another country through a poor bank network.

Although the invention has been shown and described in detail with reference to certain exemplary embodiments thereof, the present invention is not limited to the above exemplary embodiments thereof, and it will be apparent to a person having ordinary knowledge in the technical field of the present invention that various modifications, additions and substitutions are possible, without departing from the scope and spirit of the invention as disclosed in the accompanying claims. Therefore, the spirit and scope of the present invention must be defined not by the described embodiments thereof but by the appended claims and equivalents of the appended claims.

1. A system for remitting electronic money, the system comprising:
a service server for providing a remittance request signal according to a remittance request when receiving the remittance request comprising subscriber identification information of a remittee from a predetermined terminal apparatus;
an electronic money server for managing an electronic money account corresponding to subscriber identification information of each user, and requesting identification of the remittee and currency exchange/remittance according to the remittance request signal when receiving the remittance request signal from the service server; and
a relay server for when the relay server has been requested for the identification of the remittee and the currency exchange/remittance according to the remittance request signal by the electronic money server, identifying a country of the remittee based on the remittance request signal, and exchanging an amount of electronic money to be remitted according to the remittance request signal for a currency unit of the country of the remittee based on exchange rate information of each country and then providing the electronic money server in the relevant country with a remittance signal comprising information on an amount of the exchanged currency.

2. The system as claimed in claim 1, wherein the relay server is located in a roaming network.

3. The system as claimed in claim 1, wherein when receiving the remittance request from the terminal apparatus, the service server detects a communication network code corresponding to the remittee based on the subscriber identification information of the remittee included in the remittance request and then provides the electronic money server with the remittance request signal obtained by adding the communication network code to the remittance request.

4. The system as claimed in claim 3, wherein the electronic money server transmits a remittance confirmation request corresponding to the remittance request signal to the service server, and the service server transmits a message, which notifies completion of remitting electronic money to the remittee, to the terminal apparatus in response to the remittance confirmation request when receiving the remittance confirmation request from the electronic money server.

5. An electronic money server comprising:
an electronic money account manager for managing an electronic money account corresponding to subscriber identification information of each user; and
a server controller for requesting an external relay server for identification of a remittee and currency exchange/remittance according to a remittance request signal when receiving the remittance request signal comprising subscriber identification information of the remittee from an external service server.

6. The electronic money server as claimed in claim 5, wherein the remittance request signal comprises at least one of:
subscriber identification information of a remitter who makes a request for remitting electronic money to the remittee;
the subscriber identification information of the remittee;
a country code of the remittee;
a communication network code corresponding to the remittee; and
information on an amount of electronic money to be remitted.

7. The electronic money server as claimed in claim 6, wherein when the server controller is requested for remittance completion confirmation by the relay server in response to the request for the identification of the remittee and the currency exchange/remittance according to the remittance request signal, the server controller provides the service server with a remittance confirmation request which is made for notifying completion of remitting electronic money to a terminal apparatus corresponding to the subscriber identification information of the remitter, and reduces an amount of electronic money by the amount of electronic money, which has been remitted according to the remittance request signal, in a relevant electronic money account of the electronic money account manager corresponding to the subscriber identification information of the remitter.

8. The electronic money server as claimed in claim 6, wherein the server controller provides a predetermined terminal apparatus corresponding to the remittee according to a remittance signal with an electronic money remittance signal, which directs charging of electronic money corresponding to information on an amount of exchanged currency, when receiving the remittance signal comprising the information on the amount of the exchanged currency from the relay server.

9. The electronic money server as claimed in claim 8, wherein when receiving charging completion indicating charging of electronic money according to the amount of the exchanged currency in response to the electronic money remittance signal, the server controller provides the relay server with remittance completion corresponding to the remittance signal, and increases an amount of electronic money in accordance with the information on the amount of the exchanged currency in the relevant electronic money account of the electronic money account manager corresponding to the subscriber identification information of the remittee.

10. A relay server comprising:
an exchange rate information storage unit for storing exchange rate information of each country;
a currency exchange calculator for calculating an amount of exchanged currency based on the exchange rate information of each country; and
a relay server controller for when the relay server is requested for identification of a remittee and currency exchange/remittance according to a remittance request signal by an external electronic money server, identifying a country of the remittee based on the remittance request signal, requesting the currency exchange calculator to exchange an amount of electronic money to be remitted according to the remittance request signal for a currency unit of the country of the remittee, and then providing an electronic money server in the relevant country with a remittance signal comprising the information on the amount of the exchanged currency related to the currency exchange.

11. The relay server as claimed in claim 10, wherein the relay server controller provides the electronic money server in the relevant country with the remittance signal comprising a subscriber identification number of the remittee and the information on the amount of the exchanged currency and then makes a request for remitting electronic money corresponding to the information on the amount of the exchanged currency to a terminal apparatus of the remittee, and provides the electronic money server with remittance completion confirmation which makes a request for notifying completion of remitting electronic money to a terminal apparatus of a remitter according to the remittance request signal when receiving remittance completion in response to the remittance signal.

12. A method for remitting electronic money, the method comprising the steps of:
providing a remittance request signal according to a remittance request by a service server when the remittance request comprising subscriber identification information of a remittee is received from a predetermined terminal apparatus;
requesting identification of the remittee and currency exchange/remittance according to the remittance request signal by an electronic money server for managing an electronic money account corresponding to subscriber identification information of each user when the remittance request signal is received;
identifying a country of the remittee based on the remittance request signal and then exchanging an amount of electronic money to be remitted according to the remittance request signal for a currency unit of the country of the remittee based on exchange rate information of each country by a relay server, when the identification of the remittee and the currency exchange/remittance according to the remittance request signal have been requested; and
providing the electronic money server in the relevant country with a remittance signal comprising the information on the amount of the exchanged currency in response to the remittance request signal by the relay server.

13. The method as claimed in claim 12, wherein the step of providing the remittance request signal by the service server comprises the sub-steps of:
detecting a communication network code corresponding to the remittee based on the subscriber identification information of the remittee included in the remittance request received from the terminal apparatus; and
providing the electronic money server with the remittance request signal obtained by adding the detected communication network code to the remittance request.

14. The method as claimed in claim 13, further comprising a step of transmitting a message, which notifies completion of remitting electronic money to the remittee, to the terminal apparatus in response to the remittance confirmation request by the service server when the remittance confirmation request corresponding to the remittance request signal is received from the electronic money server.

15. A method for processing remittance by an electronic money server, the method comprising the steps of:
determining whether a remittance request signal comprising subscriber identification information of the remittee is received from an external service server;
requesting an external relay server for identification of a remittee and currency exchange/remittance according to the remittance request signal when the remittance request signal is received;
determining whether remittance completion confirmation is requested by the external relay server in response to the request for the identification of the remittee and the currency exchange/remittance according to the remittance request signal; and
reducing an amount of electronic money by the amount of the remitted electronic money in an electronic money account corresponding to subscriber identification information of a remitter according to the remittance request signal among multiple pieces of previously-stored subscriber identification information according to users when the remittance completion confirmation is requested.

16. The method as claimed in claim 15, wherein the remittance request signal comprises at least one of:
subscriber identification information of a remitter who makes a request for remitting electronic money to the remittee;
the subscriber identification information of the remittee;
a country code of the remittee;
a communication network code corresponding to the remittee; and
information on an amount of electronic money to be remitted.

17. The method as claimed in claim 16, further comprising a step of providing the service server with a remittance confirmation request which is made for notifying completion of remitting electronic money to a terminal apparatus corresponding to the subscriber identification information of the remitter when the remittance completion confirmation is requested.

18. The method as claimed in claim 16, further comprising the steps of:
determining whether a remittance signal comprising information on an amount of exchanged currency is received from the relay server; and
providing a predetermined terminal apparatus corresponding to the remittee according to the remittance signal with an electronic money remittance signal, which directs charging of electronic money in response to the information on the amount of the exchanged currency, when the remittance signal is received.

19. The method as claimed in claim 18, further comprising the steps of:
determining whether charging completion indicating charging of electronic money according to the amount of the exchanged currency is received in response to the electronic money remittance signal; and
providing the relay server with remittance completion corresponding to the remittance signal and increasing an amount of electronic money in accordance with the information on the amount of the exchanged currency in a relevant electronic money account of an electronic money account manager corresponding to the subscriber identification information of the remittee, when the charging completion is received in response to the electronic money remittance signal.

20. A method for processing remittance by a relay server, the method comprising the steps of:
determining whether identification of a remittee and currency exchange/remittance according to a remittance request signal are requested by an external electronic money server;
identifying a country of the remittee based on the remittance request signal and exchanging an amount of electronic money to be remitted according to the remittance request signal for a currency unit of the country of the remittee based on exchange rate information of each country, when the identification of the remittee and the currency exchange/remittance according to the remittance request signal are requested; and
providing an electronic money server in the relevant country with a remittance signal comprising the information on the amount of the exchanged currency related to the currency exchange.

21. The method as claimed in claim 20, further comprising the steps of:
determining whether remittance completion is received in response to the remittance signal, after providing the electronic money server in the relevant country with the remittance signal comprising a subscriber identification number of the remittee and the information on the amount of the exchanged currency; and
providing the electronic money server with remittance completion confirmation which makes a request for notifying completion of remitting electronic money to a terminal apparatus corresponding to a remitter according to the remittance request signal when the remittance completion is received in response to the remittance signal.
